(19) United States
(12) Patent Application Publication
(10) Pub. No.: US 2017/0357974 A1
(43) Pub. Date: Dec. 14, 2017

(54) PAYMENT PROCESSING

(71) Applicant: MASTERCARD INTERNATIONAL INCORPORATED, Purchase, NY (US)

(72) Inventor: Piyush Sharma, Pune (IN)

(21) Appl. No.: 15/615,376

(22) Filed: Jun. 6, 2017

(30) Foreign Application Priority Data
Jun. 13, 2016 (SG) 10201604803P

(51) Int. Cl. G06Q 20/40; G06Q 20/20; G06Q 30/06; G06Q 20/10; G06Q 20/26; G06Q 20/24; G06Q 20/38

(52) U.S. Cl. CPC G06Q 20/401; G06Q 30/06; G06Q 20/204; G06Q 20/202; G06Q 20/10; G06Q 20/24; G06Q 20/387; G06Q 20/26

(57) ABSTRACT

A payment processing system for processing credit/debit card payments on behalf of a merchant, the system including one or more provider processing devices that: receive a transaction file including transaction details indicative of a transaction between the merchant and a customer, the transaction details including a transaction amount provided in a first data element and a customer account identifier; determine a discounted amount associated with the transaction by applying to the transaction amount a discount that is calculated at least partially in accordance with the customer account identifier; generate a modified transaction file including the discounted amount in the first data element, the transaction amount in a second data element and the customer account identifier; and cause a credit/debit card payment associated with the transaction to be performed in accordance with the modified transaction file.

### BACKGROUND OF THE INVENTION

The present invention relates to a method and system for processing a payment, and in one example, to a method and system for processing a payment such as a credit/debit card payment.

### DESCRIPTION OF THE PRIOR ART

When credit/debit card transactions are performed, for example between a merchant and customer, the payments are processed by an acquirer and an issuer. The issuer is the entity that issues the card to the customer, and acts to debit an account of the customer, transferring funds to the acquirer, who then allocates these to the merchant. As part of this process, an interchange fee is allocated to the issuer, whilst a merchant services fee is charged to the merchant by the acquirer.

With existing payment processes, details of the transaction are passed from the merchant to the acquirer, and then from the acquirer to the issuer, as part of batch processes, typically performed on a daily basis. Once the issuer receives transaction details, they debit funds from the user, subtracting the interchange fee and passing the funds on to the acquirer.

The credit/debit card payment process is typically facilitated by transferring the details of the transaction in a standardised format in which transaction parameters, such as the payment amount, are provided as specific data elements. This allows required transaction parameters to be readily obtained by the different parties to the transaction as the process is carried out.

A range of techniques have been traditionally implemented to provide incentives for customers to use particular credit/debit cards offered by particular issuers. For example, credit/debit card issuers may offer rewards schemes or loyalty programs where points are accumulated based on transacted amounts on their credit/debit cards, and such points may be redeemed for rewards such as airfares, products or cash. However, these points are generally managed separately and require significant additional steps in the payment process. Furthermore, redemption processes are often complicated and may impact the value perceived by the customer.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a first aspect, there is provided a payment processing system for processing credit/debit card payments on behalf of a merchant, the system including one or more provider processing devices that: (a) receive a transaction file including transaction details indicative of a transaction between the merchant and a customer, the transaction details including: (i) a transaction amount provided in a first data element; and, (ii) a customer account identifier; (b) determine a discounted amount associated with the transaction by applying to the transaction amount a discount that is calculated at least partially in accordance with the customer account identifier; (c) generate a modified transaction file including: (i) the discounted amount in the first data element; (ii) the transaction amount in a second data element; and, (iii) the customer account identifier; and, (d) cause a credit/debit card payment associated with the transaction to be performed in accordance with the modified transaction file. Preferably, (i) a customer account associated with the customer account identifier is debited by the discounted amount provided in the first data element; and, (ii) a merchant payment is provided to the merchant in accordance with the transaction amount provided in the second data element.

It is preferable that the transaction file is received from an acquirer processing device that generates the transaction file in response to a customer purchase, and that the one or more provider processing devices transfer the modified transaction file to the one or more acquirer processing devices.

Preferably, the acquirer processing device uses the modified transaction file to provide to the customer a payment confirmation in accordance with the discounted amount.

It is also preferable that the payment confirmation is provided to the customer using a merchant device that receives the discounted amount from the acquirer processing device.

Preferably, the one or more provider processing devices transfer the modified transaction file to an issuer processing device, the issuer processing device being responsive to the modified transaction file to cause: (a) the customer account to be debited by the discounted amount provided in the first data element; and, (b) an issuer payment to be made from an acquirer account to an issuer account in accordance with the transaction amount provided in the second data element.

The transaction details can further include at least one transaction parameter and the one or more provider processing devices can calculate the discounted amount at least partially in accordance with the customer account identifier and the at least one transaction parameter. The transaction details can include a merchant category code for the transaction.

It is preferable that the one or more provider processing devices determine customer parameters using the customer identifier and calculate the discounted amount at least partially in accordance with at least some of the customer parameters. The customer parameters can include at least one of: (a) a card type; (b) a customer type; (c) a customer loyalty indicator; and, (d) a customer spending pattern.

Preferably, the one or more processing devices provide a discount module that: (a) determines whether to apply the discount; and, (b) in the event of a successful determination, calculates the discount. The one or more processing devices can provide decision tools that are used by the discount module to at least one of: (a) determine whether to apply the discount; and, (b) calculate the discount. The discount module can obtain a bank identification number using the customer information and can determine whether to apply the discount at least partially in accordance with the bank identification number. Moreover, upon determining to apply the discount, the discount module can request validation of the determination by an issuer processing device. In addition, upon calculation of the discount, the discount module can request approval of the discount by an issuer processing device.

It is preferable that the decision tools include at least one of: (a) a loyalty engine; and, (b) a rate engine.

Preferably, if it is determined that a discount is not to be applied, the one or more processing devices cause the credit/debit card payment to be performed in accordance with the original transaction file.

The one or more processing devices can preferably exchange bulk files with an issuer processing device to synchronise customer parameters with the issuer processing device. It is preferable that generating the modified transaction file includes setting a flag in the modified transaction file to indicate that a discount has been applied.

In another aspect, there is provided a payment processing system for processing credit/debit card payments on behalf of a merchant, the system including: (a) a merchant payment device; (b) an acquirer processing device in communication with the merchant payment device via a communications network, whereby the acquirer processing device generates a transaction file including transaction details indicative of a transaction between the merchant and a customer, the transaction details including: (i) a transaction amount provided in a first data element; and, (ii) a customer account identifier; (c) one or more provider processing devices in communication with the acquirer processing device via the communications network, whereby the one or more processing devices: (i) receive the transaction file from the acquirer processing device; (ii) determine a discounted amount associated with the transaction by applying to the transaction amount a discount that is calculated at least partially in accordance with the customer account identifier; (iii) generate a modified transaction file including: (1) the discounted amount in the first data element; (2) the transaction amount in a second data element; and, (3) the customer account identifier; and, (d) an issuer processing device in communication with the one or more processing devices and the acquirer processing device via the communications network that (i) receive the modified transaction file; and, (ii) cause a credit/debit card payment associated with the transaction to be performed in accordance with the modified transaction file. Preferably, (1) a customer account associated with the customer account identifier is debited by the discounted amount provided in the first data element; and, (2) a merchant payment is provided to the merchant in accordance with the transaction amount provided in the second data element.

In a final aspect, there is provided a method for processing credit/debit card payments on behalf of a merchant, the method including having a payment service provider: (a) receive a transaction file including transaction details indicative of a transaction between the merchant and a customer, the transaction details including: (i) a transaction amount provided in a first data element; and, (ii) a customer account identifier; (b) determine a discounted amount associated with the transaction by applying to the transaction amount a discount that is calculated at least partially in accordance with the customer account identifier; (c) generate a modified transaction file including: (i) the discounted amount in the first data element; (ii) the transaction amount in a second data element; and, (iii) the customer account identifier; and, (d) cause a credit/debit card payment associated with the transaction to be performed in accordance with the modified transaction file. It is preferable that (i) a customer account associated with the customer account identifier is debited by the discounted amount provided in the first data element; and, (ii) a merchant payment is provided to the merchant in accordance with the transaction amount provided in the second data element.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:

FIG. 1 is a flow chart of an example of a method of processing credit card payments on behalf of a merchant;

FIG. 2 is a schematic diagram of an example of a distributed computer architecture;

FIG. 3 is a schematic diagram of an example of a processing system of FIG. 2;

FIG. 4 is a schematic diagram of an example of a merchant device of FIG. 2;

FIG. 5 is a schematic diagram of an example of the interactions involved in a traditional approach to processing credit card payments;

FIG. 6 is a flowchart of an example of a traditional approach to processing credit card payments;

FIG. 7 is a schematic diagram of an example of the interactions involved in an example of a method of processing credit card payments;

FIGS. 8A and 8B are a flowchart of an example of a method of processing credit card payments; and,

FIGS. 9A to 9C are a flowchart of an example of a method of authorizing a payment with a discounted amount.

### DETAILED DESCRIPTION OF THE PREFERRED EMBODIMENTS

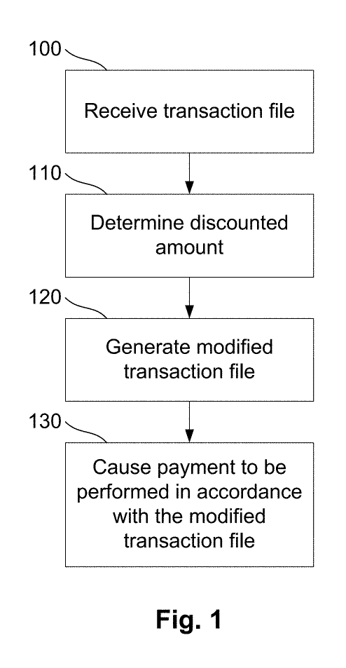

An example of a method for processing a payment associated with a credit card transaction will now be described with reference to FIG. 1. Even though the example depicted in FIG. 1 is described in relation to a credit card transaction, it should be appreciated that the example can be illustrated using a debit card transaction as well.

For the purpose of illustration, it is assumed that the process is performed at least in part using one or more electronic processing devices forming part of one or more processing systems, such as servers, which are in turn connected to one or more merchant devices, such as mobile phones, portable computers or the like, via a network architecture, as will be described in more detail below.

For the purpose of the example of FIG. 1, it is assumed that the processing devices are utilised by a service provider in order to allow payments to be processed on behalf of a merchant, and these will therefore be referred to as one or more provider processing devices. The one or more provider processing devices may interact with other processing devices operated by an acquirer or an issuer and these will therefore be referred to as acquirer processing devices and issuer processing devices. The acquirer and the issuer are typically entities such as financial institutions, banks or the like. The acquirer processes and settles a merchant's credit card transactions with the help of the issuer, which is the entity that has issued the credit card to the customer to allow the customer to make credit card payments.

Throughout the following, whilst specific reference is made to a merchant, it should be understood that the term is illustrative only and is not intended to be limiting. Accordingly, it will be appreciated that techniques could be applied to payments made to any payee. Similarly, whilst reference is made to credit card payments in particular, the techniques could be used when payment is performed using other similar mechanisms, such as when using virtual wallets, contactless payment solutions, or the like.

In this example, at step 100, the one or more provider processing devices receive a transaction file including transaction details indicative of a transaction between the merchant and a customer. The transaction file may be of any appropriate form, but will typically have a standardised format including a number of predetermined data elements in which particular transaction details will be provided to allow the required transaction details to be readily obtained by different recipients of the transaction file. Typically, the transaction details include at least a transaction amount provided in a first data element and a customer account identifier.

The transaction details can be determined in any suitable manner, depending on the preferred implementation. Typically, these are received from a merchant device, such as a POS (Point of Sales) terminal, either as part of an authorisation message or payment message. However, this is not essential, and the transaction details could be determined in any suitable manner, such as retrieving these from a database, or the like.

The transaction amount will generally be determined based on a total value of a customer purchase from the merchant. The customer account identifier may be determined from a credit card number of the customer that is provided as part of the customer purchase, such as by swiping a physical credit card with a card reader of the merchant device. It is noted that credit card numbers typically include a bank identification number (BIN) provided by the leading six digits and a primary account number (PAN) provided by the remaining digits. In some implementations the PAN may be used as the customer account identifier.

At step 110, the one or more provider processing devices determine a discounted amount associated with the transaction, by applying to the transaction amount a discount that is calculated at least partially in accordance with the customer account identifier. The discount may be calculated based on customer parameters for the customer that are obtained using the customer account identifier. In some implementations, the customer parameters may be indicative of customer spending patterns or loyalty such that discounts may be calculated to reward more frequent use of the credit card.

A modified transaction file is then generated by the one or more provider processing devices at step 120. In this example, the modified transaction file will include the discounted amount in the first data element, the transaction amount in a second data element, along with the customer account identifier. Accordingly, generating the modified transaction file may essentially involve overriding the original transaction amount with the discounted amount in the first data element of the transaction file, with the original transaction amount being relocated in a second, different data element.

At step 140, once the modified transaction file has been generated, the one or more provider processing devices can cause a credit card payment associated with the transaction to be performed in accordance with the modified transaction file. In particular, a customer account associated with the customer account identifier can be debited by the discounted amount provided in the first data element, while a merchant payment can be provided to the merchant in accordance with the transaction amount provided in the second data element.

It will be appreciated that the generation of the modified transaction file including the discounted amount in the usual place of the original transaction amount can enable a discounted payment from the customer account without requiring any manual intervention.

The application of the discount can be performed as a back-end process, with the discounted amount being determined by the service provider in a manner that will not interrupt the normal transaction flow. Nevertheless, in some implementations the service provider can share control of the discounting process by involving the issuer in the determination of the discounted amount.

Despite the modifications to the transaction file to provide the new discounted amount in place of the original transaction amount, the payment to the merchant can still proceed based on the original transaction amount since this is still provided in the modified transaction file, albeit in a different data element.

Although the customer only sees a payment of the discounted amount debited from the customer account, the payment to the merchant will nevertheless use the original undiscounted transaction amount. The discount may be absorbed by the issuer but may be at least partially offset by the issuer deducting an increased interchange fee from the amount it pays the acquirer when settling the transaction.

In any event, it will be appreciated that the seamless application of a discount to the amount debited from the customer account can facilitate a new way of incentivizing customer use of a particular credit card. In contrast to traditional rewards schemes which typically involve complex reward points systems requiring the accumulation and redemption of points, in the present method a customer will enjoy an immediate reward by paying a reduced amount compared to the actual amount of the customer purchase.

A number of further features will now be described.

The transaction file may be received from an acquirer processing device that generates the transaction file in response to a customer purchase. The one or more provider processing devices may then transfer the modified transaction file to the one or more acquirer processing devices. Accordingly, the one or more provider processing devices will perform the modifications to the transaction file to apply the discount and then return the modified transaction file to the acquirer processing device.

The acquirer processing device may subsequently use the modified transaction file to provide to the customer a payment confirmation in accordance with the discounted amount. This payment confirmation may be provided to the customer using a merchant device that receives the discounted amount from the acquirer processing device. The payment confirmation may be in the form of a charge slip reflecting the discounted amount, so the customer receives immediate feedback of the discount being applied. The customer may also receive other forms of notifications, such as a short message service (SMS) message on a registered mobile device of the customer.

The one or more provider processing devices may transfer the modified transaction file to an issuer processing device, with the issuer processing device responding to the modified transaction file to cause the customer account to be debited by the discounted amount provided in the first data element and an acquirer payment to be made from the customer account to an acquirer account in accordance with the transaction amount provided in the second data element. Typically the issuer will be participating in a discount service provided by the service provider in order to offer discounts to their cardholding customers, and will be aware of the data element structure for enabling the discounts to be applied. Accordingly, the issuer will be able to refer to the appropriate data elements for debiting the customer account and making the acquirer payment.

In some examples, the transaction details may further include at least one transaction parameter and the one or more provider processing devices may calculate the discounted amount at least partially in accordance with the customer account identifier and the at least one transaction parameter. For instance, the transaction details may include a merchant category code for the transaction, and this may influence the rate of the discount, potentially with regard to the rate of interchange fees applicable to the particular merchant category code.

The one or more provider processing devices may determine customer parameters using the customer identifier and calculate the discounted amount at least partially in accordance with at least some of the customer parameters. It will be appreciated that the use of specific customer parameters may allow the discount to be selectively applied to customers that meet certain criteria, or applied at different rates depending on customer behaviours. A range of customer parameters may be used, such as: a card type; a customer type; a customer loyalty indicator; and a customer spending pattern.

In some implementations, the one or more processing devices may provide a discount module that determines whether to apply the discount and, in the event of a successful determination, calculates the discount. The discount module may be provided by a dedicated server of the service provider and act as a central point for facilitating the discount service provided in the payment processing method.

The one or more processing devices may additionally provide decision tools that are used by the discount module to determine whether to apply the discount and/or calculate the discount. In one example, the decision tools may include a loyalty engine for evaluating customer loyalty and a rate engine for determining a discount rate to be applied. These decision tools will be managed by the service provider and algorithms governing their operation may be adjusted by the service provider over time to vary how the discount service is applied, as required.

In some specific embodiments, the discount module may obtain a bank identification number (also known as an issuer identification number) using the customer information and determine whether to apply the discount at least partially in accordance with the bank identification number. It will be appreciated that the bank identification number will typically form part of a credit card number (usually the first six digits of the primary account number or PAN), and comparison of the bank identification number with ranges of participating bank identification numbers can allow a straightforward determination of whether the customer's issuer is participating in the discount service.

In some examples, the issuer may play an active role in deciding whether to apply the discount and the level of the discount. For instance, upon determining to apply the discount, the discount module may requests validation of the determination by an issuer processing device. Afterwards, upon calculation of the discount, the discount module may additionally request approval of the discount by an issuer processing device. This provides the issuer with the opportunity to monitor how the discounts are being applied and to apply their own evaluation processes to the discount service, such as to apply anti-fraud measures to prevent abuse of the discount service.

In situations where it is determined that a discount is not to be applied, whether this is due to a determination of the service provider or a rejection of the discount by the issuer, the one or more processing devices will cause the credit card payment to be performed in accordance with the original transaction file. Thus, it will be appreciated that the payment will revert to conventional transaction processes.

In specific implementations, the one or more processing devices may exchange bulk files with an issuer processing device to synchronise customer parameters with the issuer processing device. This can ensure that decisions to apply discounts are made consistently based on up to date information, and allows the issuer to have ongoing input into how the discounts are applied.

Practical implementations of the method may also involve setting a flag in the modified transaction file to indicate that a discount has been applied. Other parties to the transaction may therefore refer to the flag to confirm whether or not the amount provided in the first data element is the actual transaction amount or the discounted amount, and thus whether to also refer to the second data element.

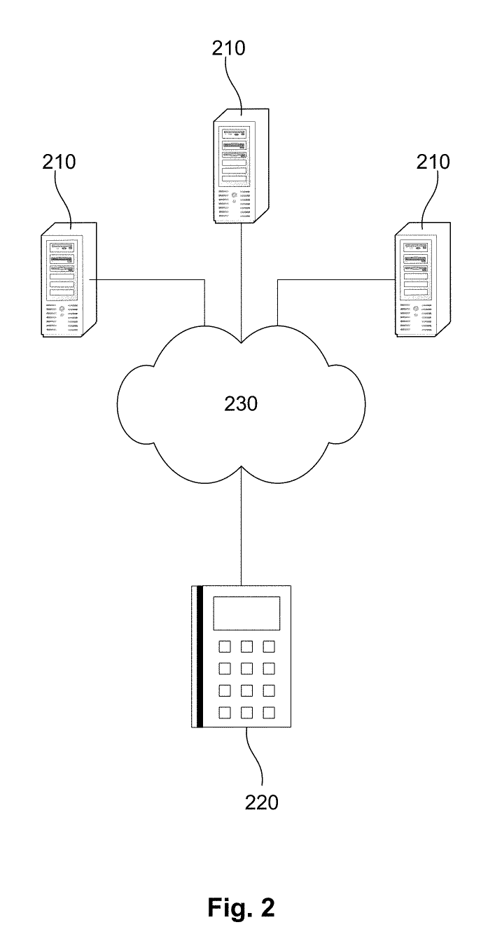

In one example, the process is performed by one or more processing systems operating as part of a distributed architecture, an example of which will now be described with reference to FIG. 2.

In this example, a number of processing systems 210 are provided coupled to one or more merchant devices 220, via one or more communications networks 230, such as the Internet, and/or a number of local area networks (LANs). The processing devices are typically operated by parties, such as acquirers, service providers and issuers, and it will therefore be appreciated that any number of processing systems and any number of merchant devices 220 could be provided, and the current representation is for the purpose of illustration only. The configuration of the networks 230 is also for the purpose of example only, and in practice the processing systems 210 and merchant devices 220 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing systems 210 are adapted to perform various data processing tasks forming part of a payment process, and the particular functionality will vary depending on the particular requirements. For example, the processing systems can be adapted to determine transaction details, determine discounted amounts, generate transaction files, determine interchange fees, implement payment services, perform payments, or cause further payment systems (not shown), such as servers of financial institutions, payment gateways or the like, to perform payments, as will be appreciated by persons skilled in the art.

Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

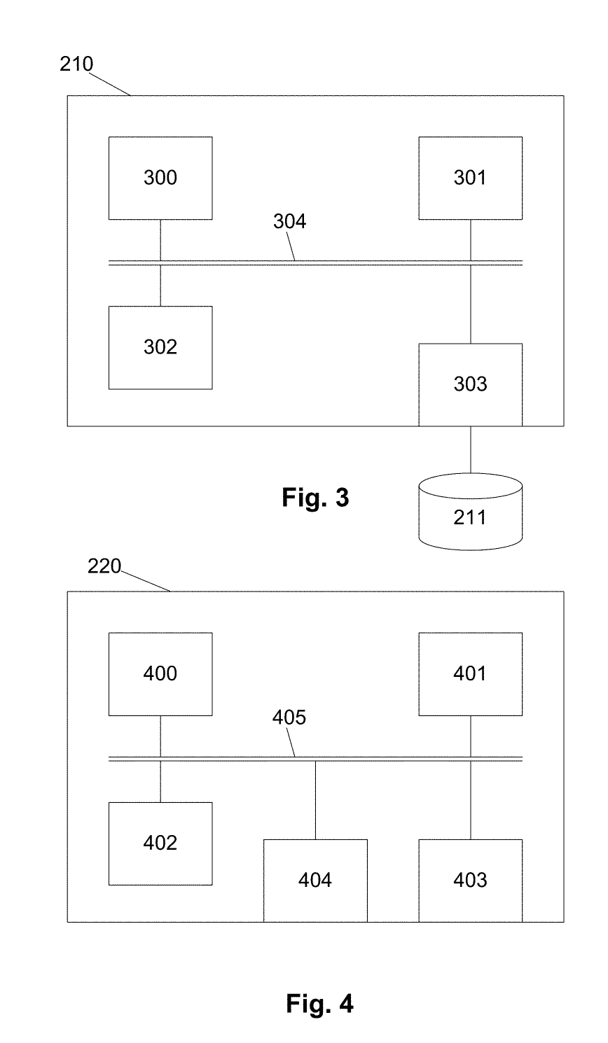

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 230, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed merchant device, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the merchant device 220 includes at least one microprocessor 400, a memory 401, an input/output device 402, such as a keyboard and/or display, an external interface 403, and typically a card reader 404, interconnected via a bus 405 as shown. In this example the external interface 403 can be utilised for connecting the merchant device 220 to peripheral devices, such as the communications networks 230 databases, other storage devices, or the like. Although a single external interface 403 is shown, this is for the purpose of example only, and in practice multiple interfaces using various methods (e.g. Ethernet, serial, USB, wireless or the like) may be provided. The card reader 404 can be of any suitable form and could include a magnetic card reader, or contactless reader for reading smartcards, or the like.

In use, the microprocessor 400 executes instructions in the form of applications software stored in the memory 401, and to allow communication with one of the processing systems 210.

Accordingly, it will be appreciated that the merchant devices 220 may be formed from any suitable processing system, such as a suitably programmed PC, Internet terminal, lap-top, or hand-held PC, and in one preferred example is either a POS terminal, or a tablet, or smart phone, with integrated or connected card reading capabilities. However, it will also be understood that the merchant devices 220 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for processing payments will now be described in further detail. For the purpose of these examples it is assumed that one or more respective processing systems 210 are servers that provide functionality required of the acquirer, the issuer and the card services provider, and will be referred to respectively as acquirer, issuer and provider servers. The servers 210 typically execute processing device software, allowing relevant actions to be performed, with actions performed by the server 210 being performed by the processor 300 in accordance with instructions stored as applications software in the memory 301 and/or input commands received from a user via the I/O device 302. It will also be assumed that actions performed by the merchant device 220, are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the different processing systems 210 may vary, depending on the particular implementation.

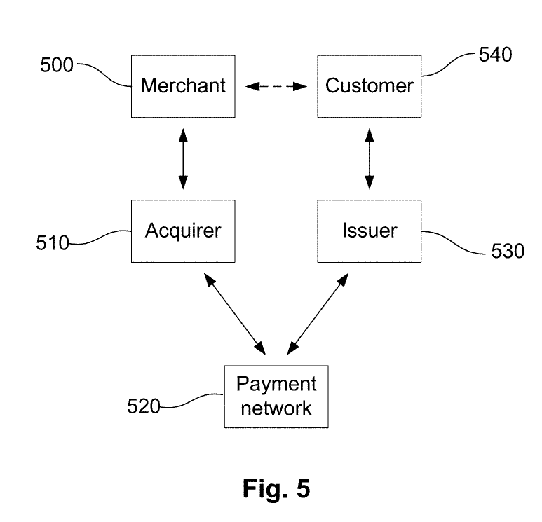

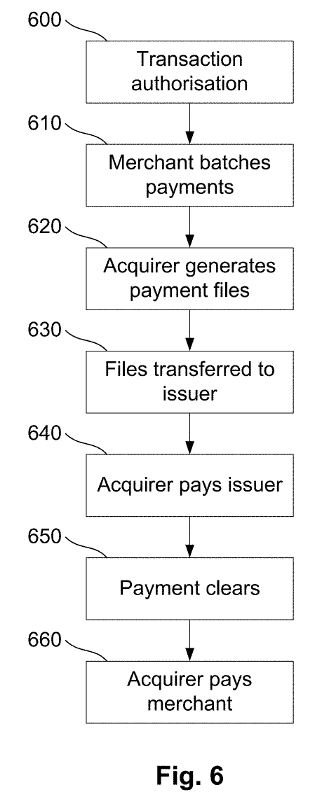

To provide context for the invention, a traditional payment process will now be described with reference to FIGS. 5 and 6.

In this example, the parties involved include a merchant 500, an acquirer 510, a service provider in the form of a payment network 520, an issuer 530 and a customer 540. The acquirer 510 is a bank that processes and settles a merchant's credit card transactions with the help of a card issuer 530, which is a financial institution, bank, credit union or company that issues or helps issue cards to cardholders, such as customers. The payment network 520 is typically a card network, such as Visa, MasterCard or other similar network that act as an intermediary between the acquirer and the issuer to authorize credit card transactions.

It will be appreciated that the merchant will utilise a merchant terminal 220, whilst the acquirer 510, a payment services provider network 520 and issuer 530, will each have a number of typically networked processing systems, in the form of respective servers 210. For the purpose of the following explanation, it will be assumed that actions performed by each of the parties are performed at least in part by the relevant terminal or server.

An example transaction process typically commences with the merchant 510 and customer 540 agreeing on a transaction, typically in response to a customer purchase of goods or services, with the merchant entering details into the merchant terminal 220, before reading the customer's credit card. At this point, an authorisation process is performed at step 600, with an authorisation request being transferred from the merchant terminal 220, via the acquirer 510 and payment network 520 to the issuer 530. Assuming the transaction meets relevant criteria, the issuer returns an authorisation code to the merchant terminal, via the payment network 520 and acquirer 510, allowing the transaction to proceed.

Once approved, the transaction is performed, with details of the completed transaction being added to a payment batch, which in general is processed on a daily basis at step 610. The batch is forwarded to the acquirer 510, which then generates payment files at step 620, for each of the respective card issuers. The payment files are transferred to the respective issuer 530, via the card network 520, allowing acquirer to pay the issuer at step 640.

Once the payment has cleared at step 650, the acquirer pays the merchant at step 660 by crediting the merchant account the transaction amount less the merchant services fee.

It is noted that the method described above with regard to FIG. 1 takes place within the authorisation process of step 600 in FIG. 6. The subsequent payment processing steps of FIG. 6 will proceed in a generally conventional matter, with the exception of the discounted amount being debited from the customer account by the issuer rather than the original transaction amount.

A specific example of the traditional payment process will now be described. In this example, a merchant 500 is running a POS terminal 220 which accepts a suitable branded credit card. The acquirer 510 signs an agreement with the merchant 500 for a fix MSF rate of say 5% for all the transactions for the respective cards. In the event a transaction is performed, the POS terminal includes a transaction of $100, with the authorization message containing a transaction amount in the data element field DE 4 of $100. The amount of $100 is authorized by the issuing bank 530 in conjunction with the payment network 520, and the customer's account is debited by the transaction amount in DE 4.

The merchant 500 batches such transactions daily, and at the end of the day submits the transactions to the acquirer 510 via settling from the POS terminal 220, using a “0500” message. A batch file is created by an acquirer switch and posted to the card network 520 via an IPM file format for receipt of funds in settlement account of the acquirer 510.

The card network 520 performs the settlement between the issuer 530 and the acquirer 510 and credits the settlement account of the acquirer 510. In doing this, the issuer 530 calculates the interchange in accordance with card network rules and returns the remaining to the acquirer 510 in settlement. For example, for a $100 transaction, if the swiped card carries an interchange of 0.5%, the value of 50 cents is kept and the amount of $99.50 is returned in the settlement to acquirer 510.

Once this amount is received by the acquirer 510 in the settlement account, the merchant has to be paid. If, for example, the acquirer charges an MSF of 5%, then the amount to be returned to the merchant is $95, with the acquirer 510 taking $4.50, returning the $95 to the merchant via TTUM credit. The Bank runs a TTUM file entry to the Core Banking system of the acquiring bank which shall debit the acquirer's settlement account and credit the merchant account with the respective merchant payment.

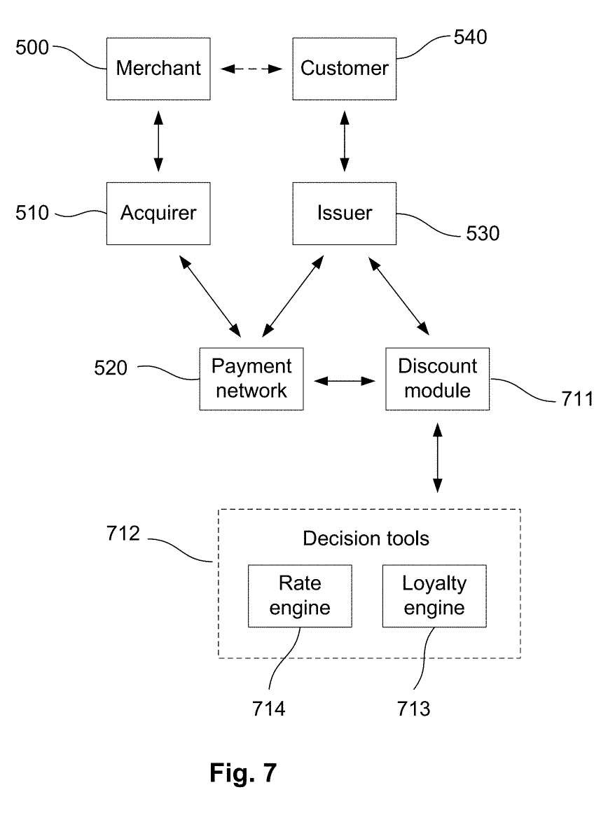

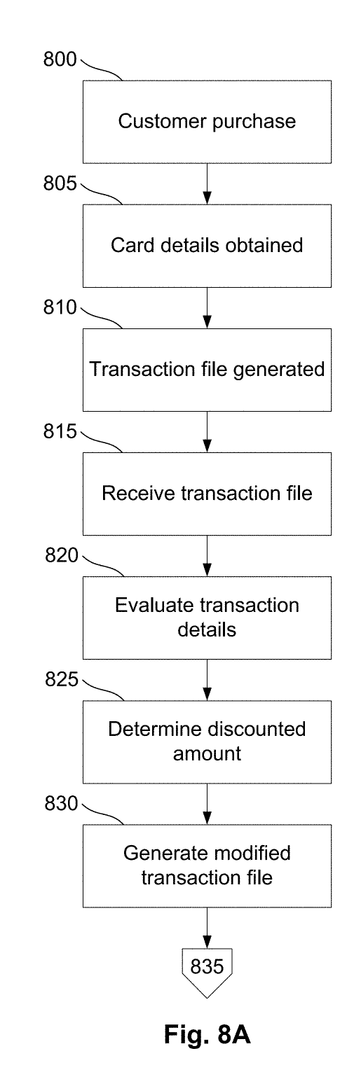

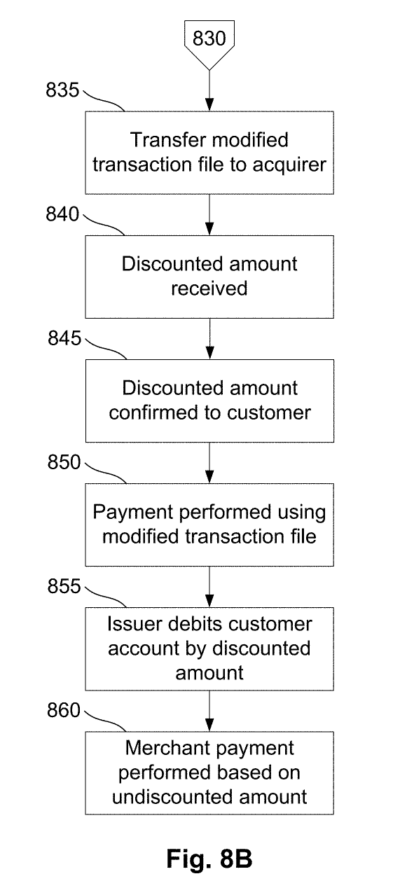

An alternative approach to processing credit/debit card payments will now be described with reference to FIGS. 7, 8A and 8B.

FIG. 7 shows the parties involved in the transaction, which again includes a merchant 500, an acquirer 510 operating an acquirer switch, a service provider in the form of a payment network 520, an issuer 530 operating an issuer switch, and a customer 540. In this example, the service provider operates a discount module 711, which may utilise a set of decision tools 712 which may also run by the service provider. In this case, the decision tools 712 may include a loyalty engine 713 and a rate engine 714 for use in the calculation of the discount. In use, the discount module 711 will primarily communicate with the payment network 520, although the issuer 530 and the discount module 711 may communicate directly to allow information relevant to the calculation of discounts to be synchronised.

An example transaction process will now be described with reference to FIG. 8.

At step 800, the transaction process is initiated when a customer makes a purchase of goods and/or services from a merchant. For example, the purchase may be made at a place of business of the merchant at a POS terminal or on the merchant's website via a suitably configured ecommerce platform. For the sake of this example it is assumed that the customer purchases goods to the value of $100 from the merchant.

The customer will then opt to pay by credit/debit card and card details will be obtained at step 805. For instance, the customer's credit/debit card may be swiped at the merchant's POS terminal or entered into a payment portal on the merchant's website. The card details and details of the payment including the transaction amount will then be used to generate the transaction file at step 810. The transaction file may be in the form of an authorization message, typically in ISO8583 format, such as an “MTI 0100” authorization request message, which is generated in the merchant's POS terminal and passed on to the acquirer. In this case, the transaction amount of $100 is provided in the data element field DE 4.

Following generation of the transaction file, the transaction flows from the acquirer switch to the service provider via the payment network. Thus, the transaction file is received by the service provider at step 815. Typically, issuers will need to opt in for the discount service provided by the service provider, and the service provider can determine whether the particular issuer of the customer's card has opted of the discount service based on the card details.

Assuming the issuer has opted in to the discount service, the transaction details may be evaluated by the service provider at step 820, to determine whether to apply a discount. This evaluation will typically be conducted in the discount module 711 with regard to the decision tools 712 as shown in FIG. 7. The transaction file may evaluated on parameters such as the merchant category code for the transaction, the type of card, the type of customer, and other internal indicators available to the service provider. Information for assisting this analysis may be synchronised between the service provider and the issuer using bulk files including relevant customer information that may be periodically updated by wither party.

Once this evaluation is completed, service provider and the issuer may determine the discounted amount to be debited to the customer at step 825. Again, this may depend on similar information as mentioned above for the evaluation. For the purpose of this example the discounted amount is assumed to be $98. Once the discounted amount is decided, the modified transaction file may be generated at step 830. The modified transaction file will be generated based on the original transaction file but with revisions to some specific data elements.

In this example, the actual transaction amount of $100 may effectively be relocated from the DE 4 data element to another data element, specifically the DE 54 data element. The DE 4 data element of the modified transaction file shall now carry the discounted amount value of $98. Accordingly, the DE 54 data element will carry the actual transaction amount for this in response to the discount being applied, whereas DE 4 shall carry the discounted amount. A predetermined flag may be set to indicate that the modified transaction file involves participation in the service provider's discount service.

At step 835, the modified transaction file may then be transferred to the acquirer via the payment network. The modified transaction file may be transferred in an “MTI 0110” request response message that is ultimately passed to the merchant's POS terminal in response to the aforementioned “MTI 0100” authorisation request message. As a result, at step 840 the merchant's POS terminal will receive the discounted amount rather than the actual transaction amount in DE 4.

At step 845, the discounted amount is confirmed to the customer. For example, the POS terminal may print a charge slip of $98. This will be based on the DE 4 value and as such the POS terminal will not need to take any special steps to confirm the discounted amount. The POS terminal will simply follow the standard charge slip procedures to print the DE 4 value, which provides the discounted amount rather than the original transaction amount as would usually be the case under conventional procedures. Additionally, the customer may be sent an SMS stating the discount applied on the transaction.

At step 850 the payment will be performed using the modified transaction file, whereby the remainder of the transaction process will proceed in a generally conventional manner as discussed previously with regard to FIG. 6, with the exception that the issuer debits the customer account by the discounted amount as indicated in step 855, although the merchant payment will be performed based on the undiscounted transaction amount as indicated in step 860.

As per the discussion of the charge slip above, debiting the customer account by the discounted amount instead of the original transaction amount will not require any special steps on behalf of the issuer. This is because the discounted amount of $98 as provided in the first data element DE 4 has effectively of overridden the original transaction amount that would otherwise be debited from the customer account. Once the funds have been debited from the customer account, the customer can move out of the transaction.

The actual transaction amount as provided in the second data element DE 54 will be referred to in the subsequent steps for settling the transaction. The parties involved in the transaction will be alerted to the fact that a discount has been applied to the DE 4 value and that the original transaction amount is now provided in DE 54 by the flag that was set when the modified transaction file was generated. Otherwise, the rest of the transaction process will follow steps 610 to 660 of FIG. 6 as previously described.

It will be appreciated that the above described method may provide a range of benefits to the customer when using a participating credit/debit card for their payments.

For a transaction the cardholder may prefer to use the participating credit/debit card over other cards because the customer can pay a discounted amount for some transactions when shopping online or through POS. The discount has immediate effective from the customer's perspective, as the customer instantly receives confirmation that a discounted amount of $98 has been debited instead of $100. No customer actions are needed to take advantage of the discount service, in contrast to other incentive schemes where complex redemption processes may be needed. Thus, the customer will feel motivated to use the participating credit/debit card over other credit/debit cards.

The discount service may be implemented without any terms and conditions imposed on the customer. The account statement of the customer shall reflect the discounted amount, without any hidden fees.

Furthermore, the discount service may be applicable to any merchant accepting credit/debit card payments via the service provider, without requiring any other specific merchant participation or modifications to the transaction process from the perspectives of the merchant or the customer. Thus, the customer can take advantage of the discount service for any transaction that could be paid using their credit/debit card.

This discount service will not constrain issuers to a regular deduction in purchase cost, but it may vary issuer to issuer. In preferred implementations, the final decision on the deduction in amount may be made by the issuer. The issuer can therefore validate its portfolio and then decide on the segments for which discounts may be applied. Specific benefits to the issuer may include an increase in the number of credit/debit card transactions received by the issuer switch as the discounts encourage customers to use their credit/debit cards for more purchases. The customer may be inclined towards using their credit/debit card over cash in view of the ability to immediately obtain discounts. Accordingly, the issuer's card penetration may increase, which may in turn increase the issuer's customer base.

This discount feature will not necessarily be specific to particular cards but could be applied to the whole portfolio of cards offered through a service provider. It should be appreciated that the payment service provider may also see a range of benefits. Customers anywhere in the world would be happy if the debited amount stands less than the actual amount of purchase. This may result in increased adoption of credit/debit cards facilitated by the service provider, as customers are likely to prefer credit/debit cards which provide immediate discounts irrespective of location, geography, merchant, terminal etc.

A detailed example of the transaction process will now be described to highlight further preferred implementation features. The different interactions will be explained covering the typical transaction cycles involving Authorization, Clearing and Settlement.

The Authorization cycle commences when the customer approaches the merchant to purchase goods worth $100 with one of the service provider's cards. The merchant accepts the card and swipes it, with details of the transaction. The transaction is initiated by the merchant with the following specific DE values:
DE 2 (PAN); and,

DE 4 (Amount): $100.
The amount shall flow from the acquirer switch to the service provider's payment network. At this stage there shall be no change in the Authorization Request (“0100”) message and shall flow as per business as usual.

Once the transaction reaches the payment network, the service provider shall identify the issuer and check whether the issuer has opted for the discount service. If yes, the payment network shall forward the request to the service provider's server responsible for handling the request (i.e. the provider processing device). This server shall provide the aforementioned discount module and be designed to consider the following parameters:
card holder spending pattern;
interchange values and indicators; and,
issuer discretion.

With regard to the server, it is noted that this will preferably work in parallel with the usual payment network processes. Ideally there will be no interaction with the transaction time and flow when implementing the discount service using the server.

The server may be synchronised with the issuer switch via a new set of bulk files. There shall be an exchange of these bulk files between the issuer and service provider, for example via the discount module 711 as shown in FIG. 7. These bulk files shall be received along with other bulk files, as the service provider may receive to facilitate other aspects of the transaction process.

The bulk files shall contain information on:
details of participating BINs under the discount service (the issuer may open up all BINs or specific BINs); and,
the discount agreed between the service provider and the issuer.

Synchronisation of the bulk files will allow regular updates on the BINs and the discount rates. There may be two bulk files exchanged in the system. One bulk file shall be communicated one way (i.e. from the service provider to the issuer). The other file shall be communicated the other way (i.e. from the issuer to the service provider).

For example, a “T333” file may be communicated from the service provider to the issuer, and an “R334” file may be communicated from the issuer to the service provider. The “T333” file shall contain fields with details and analysis by the service provider for the specified BIN ranges. These shall be suggested values for specific BINs. Also, there may be some minimal decrease in the interchange to be charged to the acquirer by issuer (if decided upon by the service provider and the issuer). The data shall prove a suggestion point to issuer. On the other hand, the “R334” file shall be the final file from the issuer to the service provider. This file shall contain, for example, agreed and confirmed values/discounts applied to each cards. The required components for operating the discount service will typically be operated by the service provider. The issuer only needs to confirm on the values via the “R334” bulk file.

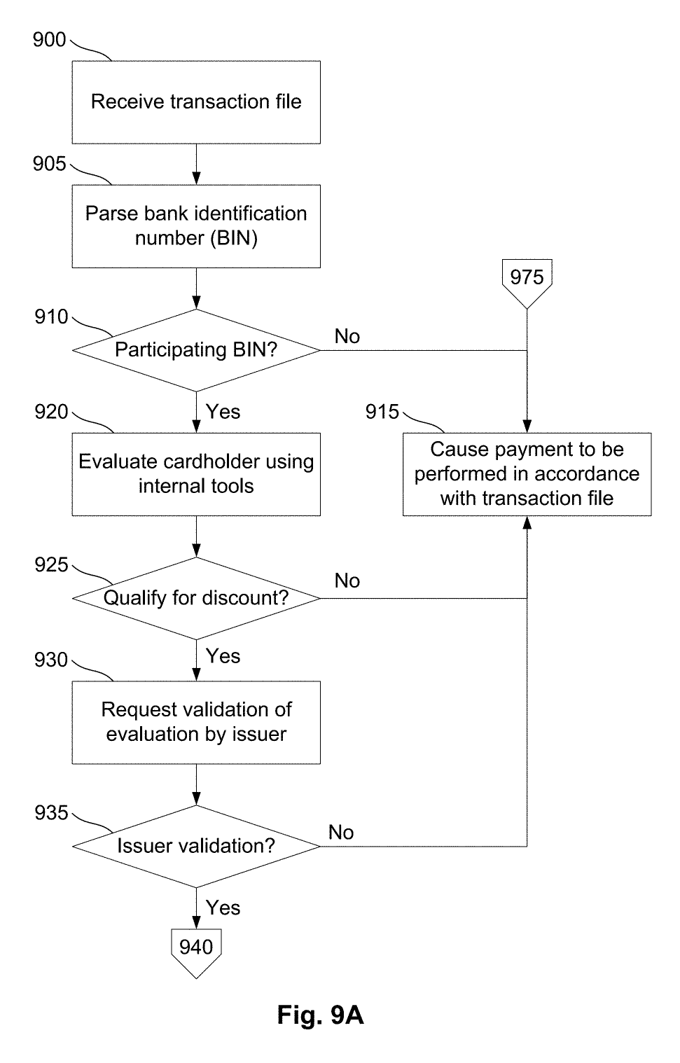

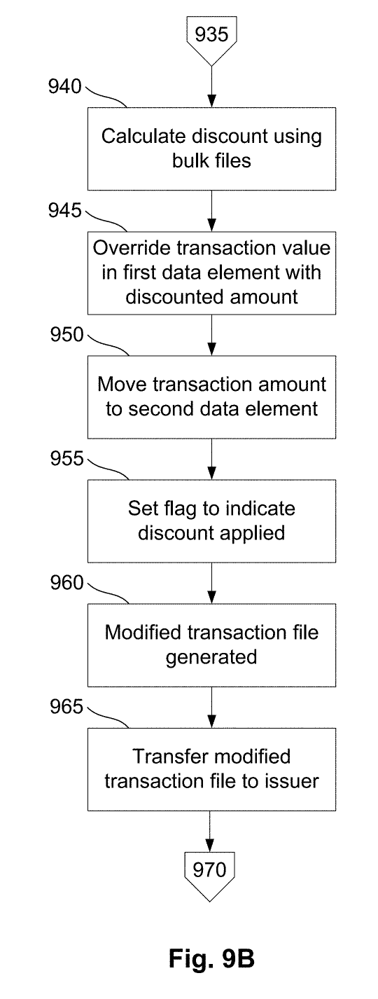

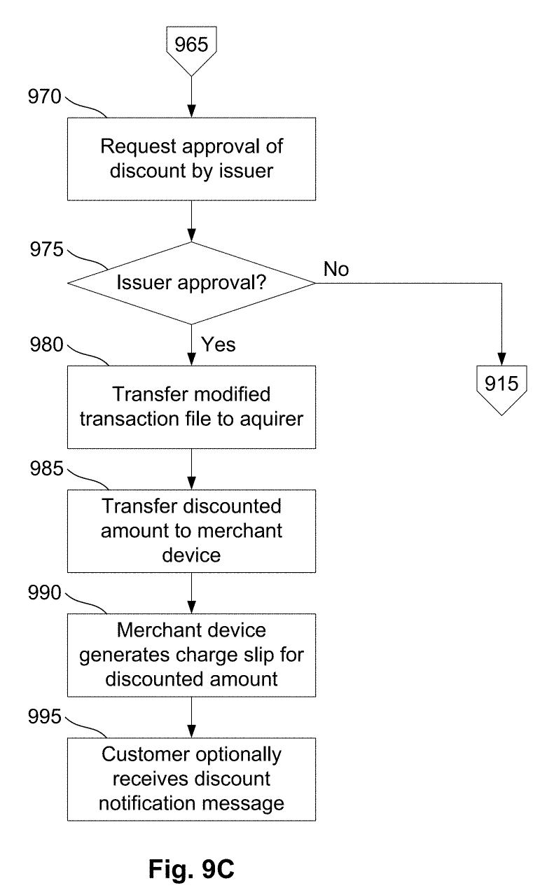

An example of specific interactions involved in having the server provide the discount service during the Authorization stage will be described with regard to FIGS. 9A to 9C. Even though the example depicted in FIGS. 9A to 9C is described in relation to credit card use, it should be appreciated that the example can also relate to debit card use.

This example assumes the transaction file has been generated when the transaction originates at the merchant/acquirer end. The transaction file is received by the service provider's server via the payment network at step 900. The transaction file flowing through the payment network to the discount module shall contain original transaction amount for the transaction.

Once the transaction file is received, the BIN shall be parsed from the credit card number and calculation shall be performed to determine whether a discount is to be provided or not, with respect to inputs provided by:
the decision tool;
bulk files exchanged with the issuer; and,
any promotional discount that may be offered by the service provider.

For example, the server may initially consider whether the transaction file corresponds to a participating BIN at step 910. This may involve a comparison of the BIN against BIN ranges that participate in the discount service. If the BIN is not participating in the discount service, the server will not apply any discount or modify the transaction file, and will simply cause the payment to be performed in accordance with the transaction file as per conventional transaction processes.

However, if the BIN is participating, then the individual cardholder will then be evaluated using the server's internal decision tools at step 920. The intelligence of bulk files exchanged between MasterCard and issuer shall be because of the decision tools and especially the loyalty engine.

The decision tools may evaluate a cardholder on the basis of:
spending patterns;
loyalty; and,
card type.

In some examples, combinations of cardholder parameters as discussed above and other transaction parameters may be considered in the evaluation. For example, the evaluation may consider a combination of card type and merchant category code combination, or a combination of regional/intra regional information and the card type.

If the cardholder is not considered to qualify for the discount at step 925, then the payment will simply be performed without a discount, in accordance with the original transaction file at per step 915. Otherwise, if the cardholder does qualify for the discount, the evaluation parameters may be provided to the issuer, where the issuer can validate, confirm or reject a discount claim at step 930.

The final decision on whether or not to apply a discount may rest with the issuer. This can allow the issuer to make a final decision on the basis of its fraud and risk management tool or any other internal tools they may have to derive this. If the issuer rejects the discount decision at the validation step 935, the transaction will revert to conventional procedures and the payment will be performed in accordance with the original transaction file at step 915.

If the issuer validates the evaluation outcome and confirms that the discount may be applied at step 935, the amount of the discount will be calculated with regard to the bulk files at step 940. The bulk files received from the issuer via message “R333” as discussed above shall decide the value in which the service provider shall discount the purchase of the cardholder.

At step 945, the value of the first data element originally providing the transaction amount, DE 4, shall now be overridden by the new discounted amount. Then, at step 950, the original value of DE 4 will be moved to a second data element, DE 54, which shall carry the original transaction amount. At step 955, a flag in PDS (Private Data element) 48 shall be set, which shall indicate that the transaction is overridden by the service provider as per discount rates. Thus, the modified transaction file will have been generated as indicated at step 960.

The remainder of the details shall flow as per the previously discussed authorization cycle. The “0100” packet shall be transposed by new values of the modified transaction file and shall be provided to the issuer at step 965.

The approval of the discount by the issuer is requested at step 970. The issuer shall have a final opportunity to decline the discount in case some fraud is suspected. This final approval shall completely rest with the issuer. In the event approval is not given by the issuer at step 975, the modified transaction file may be discarded and the transaction may proceed without the discount as per step 915.

In the event the discount is approved by the issuer at step 975, the transaction file shall carry DE 39 as 00 and shall be transferred to the acquirer for response at step 980. It is noted again that the value in DE 4 shall be the approved discounted amount (which shall obviously be less, than the original transaction amount reflecting the actual value of the customer's purchase). The DE 54 data element shall carry the original transaction amount to the acquirer. This shall be mandatory for the acquirer for reconciliation. The acquirer shall refer to the PDS 48 flag value to identify the transaction as a discounted transaction.

At step 985, the acquirer shall fetch the data from the DE4 (Amount) and shall transfer this to the merchant device at step 985. Then, at step 990, the merchant device may generate a charge slip for the discounted amount. In a POS terminal transaction this may involve printing a charge slip. The charge slip shall contain the discounted amount. The customer may also optionally receive a discount notification message at step 995, via SMS or the like, to ensure the customer is aware of the value of the discount that has been received and thus immediately reinforce the benefits of the discount service to the customer.

It will be appreciated from the above that no manual intervention is required to facilitate the discount and all understanding to give a discount or not shall rest with the issuer and the service provider.

Upon completion of the Authorization cycle, the Clearing cycle may be performed. The discount service has been designed so that the clearing cycle shall run as per conventional techniques. The DE 4 value shall be the approved discounted amount. Also, DE 54 shall carry the original transaction amount. The PDS 48 flag shall carry information of the scheme. The merchant/acquirer shall be paid as per the actual price of the products purchased. The discounting service is provided for cardholding customers by issuers and the service provider, but the acquirer cycle shall remain same and shall not be affected.

Finally, in the Settlement Cycle, it will be appreciated that the settlement amount shall be the DE 54 transaction amount. It shall not include any linkage to the DE 4 discounted amount. At the settlement day, the amount credited shall be based on the original undiscounted transaction amount. All other rules of settlement shall remain same.

In summary, it will be appreciated that the payment process incorporating a discount service as described above will help to incentivize credit/debit card usage by customers by returning immediate value to the customers in the form of a discounted payment. It shall attract customers to the service provider, as the benefits are being credited at the instant. No extra charges will be required to support the service, and there is no extra burden on the merchant. Accordingly, it is expected that consumers will prefer transacting through a service provider offering the discount service.

As a result, the discount service may be offered with the aim of increasing the card base of the issuer, due to the incentive of cash benefits being passed instantly to the customers. The discount service may be made available at any terminal across the globe accepting the service provider's cards, thus providing a strong differentiator between service providers. The issuer shall benefit as customers would be attracted towards the card issuer which may result in increased revenues.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A payment processing system for processing credit/debit card payments on behalf of a merchant, the system including one or more provider processing devices that:
a) receive a transaction file including transaction details indicative of a transaction between the merchant and a customer, the transaction details including:
i) a transaction amount provided in a first data element; and,
ii) a customer account identifier;
b) determine a discounted amount associated with the transaction by applying to the transaction amount a discount that is calculated at least partially in accordance with the customer account identifier;
c) generate a modified transaction file including:
i) the discounted amount in the first data element;
ii) the transaction amount in a second data element; and,
iii) the customer account identifier; and,
d) cause a credit/debit card payment associated with the transaction to be performed in accordance with the modified transaction file, wherein:
i) a customer account associated with the customer account identifier is debited by the discounted amount provided in the first data element; and,
ii) a merchant payment is provided to the merchant in accordance with the transaction amount provided in the second data element.

2) A system according to claim 1, wherein the transaction file is received from an acquirer processing device that generates the transaction file in response to a customer purchase, and wherein the one or more provider processing devices transfer the modified transaction file to the one or more acquirer processing devices.

3) A system according to claim 2, wherein the acquirer processing device uses the modified transaction file to provide to the customer a payment confirmation in accordance with the discounted amount.

4) A system according to claim 3, wherein the payment confirmation is provided to the customer using a merchant device that receives the discounted amount from the acquirer processing device.

5) A system according to claim 1, wherein the one or more provider processing devices transfer the modified transaction file to an issuer processing device, the issuer processing device being responsive to the modified transaction file to cause:
a) the customer account to be debited by the discounted amount provided in the first data element; and,
b) an issuer payment to be made from an acquirer account to an issuer account in accordance with the transaction amount provided in the second data element.

6) A system according to claim 1, wherein the transaction details further include at least one transaction parameter and the one or more provider processing devices calculate the discounted amount at least partially in accordance with the customer account identifier and the at least one transaction parameter.

7) A system according to claim 6, wherein the transaction details include a merchant category code for the transaction.

8) A system according to claim 1, wherein the one or more provider processing devices determine customer parameters using the customer identifier and calculate the discounted amount at least partially in accordance with at least some of the customer parameters.

9) A system according to claim 8, wherein the customer parameters include at least one of:
a) a card type;
b) a customer type;
c) a customer loyalty indicator; and,
d) a customer spending pattern.

10) A system according to claim 8, wherein the one or more processing devices provide a discount module that:
a) determines whether to apply the discount; and,
b) in the event of a successful determination, calculates the discount.

11) A system according to claim 10, wherein the one or more processing devices provide decision tools that are used by the discount module to at least one of:
a) determine whether to apply the discount; and,
b) calculate the discount.

12) A system according to claim 11, wherein the decision tools include at least one of:
a) a loyalty engine; and,
b) a rate engine.

13) A system according to claim 10, wherein the discount module obtains a bank identification number using the customer information and determines whether to apply the discount at least partially in accordance with the bank identification number.

14) A system according to claim 10, wherein, upon determining to apply the discount, the discount module requests validation of the determination by an issuer processing device.

15) A system according to claim 10, wherein, upon calculation of the discount, the discount module requests approval of the discount by an issuer processing device.

16) A system according to claim 10, wherein, if it is determined that a discount is not to be applied, the one or more processing devices cause the credit/debit card payment to be performed in accordance with the original transaction file.

17) A system according to claim 1, wherein the one or more processing devices exchange bulk files with an issuer processing device to synchronise customer parameters with the issuer processing device.

18) A system according to claim 1, wherein generating the modified transaction file includes setting a flag in the modified transaction file to indicate that a discount has been applied.

19) A payment processing system for processing credit/debit card payments on behalf of a merchant, the system including
a) a merchant payment device;
b) an acquirer processing device in communication with the merchant payment device via a communications network, wherein the acquirer processing device generates a transaction file including transaction details indicative of a transaction between the merchant and a customer, the transaction details including:
i) a transaction amount provided in a first data element; and,
ii) a customer account identifier;
c) one or more provider processing devices in communication with the acquirer processing device via the communications network, wherein the one or more processing devices:
i) receive the transaction file from the acquirer processing device;
ii) determine a discounted amount associated with the transaction by applying to the transaction amount a discount that is calculated at least partially in accordance with the customer account identifier;
iii) generate a modified transaction file including:
(1) the discounted amount in the first data element;
(2) the transaction amount in a second data element; and,
(3) the customer account identifier; and,
d) an issuer processing device in communication with the one or more processing devices and the acquirer processing device via the communications network that
i) receive the modified transaction file; and,
ii) cause a credit/debit card payment associated with the transaction to be performed in accordance with the modified transaction file, wherein:
(1) a customer account associated with the customer account identifier is debited by the discounted amount provided in the first data element; and,
(2) a merchant payment is provided to the merchant in accordance with the transaction amount provided in the second data element.

20) A method for processing credit/debit card payments on behalf of a merchant, the method including having a payment service provider:
a) receive a transaction file including transaction details indicative of a transaction between the merchant and a customer, the transaction details including:
i) a transaction amount provided in a first data element; and,
ii) a customer account identifier;
b) determine a discounted amount associated with the transaction by applying to the transaction amount a discount that is calculated at least partially in accordance with the customer account identifier;
c) generate a modified transaction file including:
i) the discounted amount in the first data element;
ii) the transaction amount in a second data element; and,
iii) the customer account identifier; and,
d) cause a credit/debit card payment associated with the transaction to be performed in accordance with the modified transaction file, wherein:
i) a customer account associated with the customer account identifier is debited by the discounted amount provided in the first data element; and,
ii) a merchant payment is provided to the merchant in accordance with the transaction amount provided in the second data element.
